(19) United States
(12) Patent Application Publication
(10) Pub. No.: US 2026/0270827 A1
(43) Pub. Date: Sep. 10, 2026

(54) METHOD AND COMMUNICATION NETWORK NODE

(71) Applicant: NEC CORPORATION, Minato-ku, Tokyo (JP)

(72) Inventors: Zhe CHEN, Guildford (GB); Sadafuku Hayashi, Tokyo (JP)

(73) Assignee: NEC Corporation, Minato-ku, Tokyo (JP)

(21) Appl. No.: 18/881,377

(22) PCT Filed: Aug. 1, 2023
(86) PCT No.: PCT/JP2023/028166

§ 371 Date: Jan. 6, 2025

(30) Foreign Application Priority Data
Sep. 8, 2022 (GB) 2211627.1

(51) Int. Cl. H04W 36/22; H04W 28/08; H04W 36/00; H04W 36/30; H04W 56/00

(52) U.S. Cl. CPC H04W 36/22; H04W 28/0942; H04W 36/0058; H04W 36/30; H04W 56/0015

(57) ABSTRACT

A method performed by an access network node of a communication network is disclosed, the method comprising: sending, to another node of the communication network, input data including at least one data item from a group of: i) at least one Synchronisation Signal Block, SSB, index of an SSB that overlaps with a cell of the another node and a number of UE per the SSB that overlaps with the cell of the another node; ii) hardware load data indicating a hardware load of the access network node; iii) radio resource load data indicating a radio resource load of the access network node; and iv) purpose data indicating a purpose of a model to be trained or to be updated by the another node, wherein the input data is used for training a model for outputting at least one parameter for load balancing.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to load balancing techniques in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 2 and NPL 3 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or access network node or RAN node is used herein to refer to any such node.

Some of the additional developments in 3GPP relate to the use of artificial intelligence (AI) and machine learning (ML), often abbreviated to AI/ML. Several use cases have been proposed for AI/ML, one being in the context of load balancing. In general, load balancing is a process by which the traffic in the radio access network is distributed, as evenly as possible, among cells and among areas of cells. Alternately, load balancing may instead involve the transfer of part of the traffic from congested cells or from congested areas of cells, or to offload users from one cell, cell area, carrier or radio access technology (RAT) to improve network performance, as evenly as possible. Such balancing may be realised by way of optimisation of handover parameters used in the radio access network, as well as the handover actions taken by the RAT.

### CITATION LIST

### Non Patent Literature

NPL 1: ‘NGMN 5G White Paper’ V1.0 by the Next Generation Mobile Networks (NGMN) Alliance, <https://www.ngmn.org/5g-white-paper.html>
NPL 2: 3GPP TS 38.300 V16.7.0
NPL 3: 3GPP TS 37.340 V16.7.0
NPL 4: 3GPP TS 22.368 V13.1.0

### SUMMARY OF INVENTION

### Technical Problem

In this regard, it will be appreciated that the significant growth in network traffic, in addition to the plurality of frequency bands used in commercial network deployments, have made it particularly difficult for network operators to steer the traffic in a balanced manner when applying known load balancing techniques. Specifically, current load balancing decisions relying on the current/past-state cell load status are insufficient relative to the rapid changes in the traffic load and resource status of the network, particularly in the context of advanced 5G networks. For instance, scenarios involving high-mobility and large number of connections may lead to ping-pong handover between different cells, cell overload and ultimately degradation of user service quality.

There is therefore a desire to make better load balancing decision in telecommunications networks. Base stations can do this if they have more accurate load information of at least one cell they control and/or more accurate load information of neighbouring cells.

Accordingly, the present disclosure seeks to provide methods and associated apparatus that address or at least alleviate (at least some of) the above-described issues. The present disclosure is set out in the appended independent claims. Optional features are set out in the appended dependent claims.

### Solution to Problem

According to one aspect, a method is provided that is performed by an access network node of a communication network. The method comprises: sending, to another node of the communication network, input data including at least one data item from a group of: i) at least one Synchronisation Signal Block, SSB, index of an SSB that overlaps with a cell of the another node and a number of UE per the SSB that overlaps with the cell of the another node; ii) hardware load data indicating a hardware load of the access network node; iii) radio resource load data indicating a radio resource load of the access network node; and iv) purpose data indicating a purpose of a model to be trained or to be updated by the another node. The input data may be used for outputting at least one parameter for load balancing.

In a case where the input data includes the radio resource load data, the input data may indicate a usage of physical resource blocks, PRBs, by the access network node.

In a case where the input data includes the hardware load data or the radio resource load data, the input data may represent a filtered average load of the access network load over a past certain period. The filtered average load may be represented by a general load state descriptor (such as ‘low’, ‘medium’, ‘high’) or by a percentage of a predetermined load (such as 20% of available capacity).

In a case where the input data includes the purpose data, the purpose data may be one of Load Balancing, Mobility Robustness, and Energy Saving.

The method may further comprise receiving measurement reports from one or more user equipment, UE, served by the access network node or another access network node, and the sending may be performed by sending the input data together with the measurement reports.

The method may further comprise receiving the model trained by the input data; and using the model to output the at least one parameter for load balancing. The model may include a mapping table which associates a power of at least one SSB of the access network node with a number of UEs that provide at least one measurement report for at least one access network node which is a neighbour to the access network node.

According to another aspect, a method is provided that is performed by an access network node. This method may be performed by the same or a different access network node that performed the first method. The method comprises: receiving a model including a mapping table which associates a power of at least one Synchronisation Signal Block, SSB, of the access network node with a number of user equipment, UE, that provide at least one measurement report for at least one neighbouring access network node which is neighbour to the access network node; receiving input information from the at least one neighbouring access network node; and using the input information and the model to determine at least one load balancing action to be performed by the access network node, wherein the input information includes at least one data item from a group of: i) at least one Synchronisation Signal Block, SSB, index of an SSB that overlaps with a cell of each of the at least one neighbouring access network node and a number of UE per the SSB that overlaps with the cell of the each of the at least one neighbouring access network node; ii) hardware load data indicating a hardware load of the access network node; and iii) radio resource load data indicating a radio resource load of the access network node.

The at least one load balancing action may include at least one of: varying (increasing and/or decreasing) a transmit power of the at least one SSB, changing at least one handover decision parameter used by the access network node to determine when to handover a UE to a neighbouring access network node, changing a number of measurement events that trigger handover of a UE to a neighbouring access network node, changing a time elapsed after measurement events are reported to trigger handover, and changing a measurement configuration for at least one UE and transmitting the measurement configuration to the at least one UE.

The at least one load balancing action may occur in a case where at least one of: a loading on the SSB is greater than a loading on the at least one neighbouring access network node, and a loading on the at least one neighbouring access network node is greater than a loading on the at least one SSB. The at least one load balancing action may include decreasing the transmit power of the at least one SSB in a case where a loading on the SSB is greater than a loading on the at least one neighbouring access network node. The at least one load balancing action may include increasing the transmit power of the at least one SSB in a case where a loading on the at least one neighbouring access network node is greater than a loading on the at least one SSB.

The at least one action may include changing a measurement configuration for at least one UE and transmitting the measurement configuration to the at least one UE, and the measurement configuration may define the circumstances that cause the at least one UE to send a measurement report to the access network node.

In some example embodiments, the method may further comprise: transmitting another input information relating to a load on the access network node to a neighbouring access network node for load balancing purposes, wherein the another input information includes at least one data item from a group of: SSB index of an SSB that overlaps with a cell of the neighbouring access network node and a number of UE per the SSB that overlaps with the cell of the neighbouring access network node, hardware load, and radio resource load. The another input data may be updated input data.

The method may further comprise receiving measurement reports transmitted from one or more user equipment, UEs, served by the access network node or another access network node, and wherein the using is performed using the measurement reports.

According to another aspect a method is provided that is performed in a communication network. The method comprises: receiving input data from at least one of a plurality of access network nodes; and using the input data from the at least one of the plurality of access network nodes and a model to determine at least one load prediction for the at least one of the plurality of access network nodes, wherein the at least one load prediction includes at least one data item from a group of: i) a total number of user equipment, UEs, that are served by the at least one access network node; ii) a number of UEs per Synchronisation Signal Block, SSB, of the at least one access network node; iii) a number of UEs that are served by the at least one access network node that will send a measurement report identifying a given neighbouring cell; and iv) a predicted Radio Resource Load for the at least one access network node. The input data may include at least one of: i) at least one SSB index of an SSB that overlaps with a cell of a neighbouring access network node which is a neighbour to one of the at least one access network node and a number of UE per the SSB that overlaps with the cell of the neighbouring access network node; ii) hardware load data indicating a hardware load of the access network node; iii) radio resource load data indicating a radio resource load of the access network node; and iv) purpose data indicating a purpose of the model to be trained or to be updated. The method may be performed by a model inference node or an access network node of the communication network and the model that is used may be obtained from a model training function.

The at least one of the data items of the at least one load prediction may include a deviation from a predicted number which is indicated by the at least one of the data items.

In a case where at least one of the data items of the at least one load prediction includes a predicted Radio Resource load for the at least one access network node, the predicted Radio Resource Load may include a Physical Resource Block usage per cell or per SSB.

The method may further comprise: using the at least one load prediction, the model and input data from neighbour access network node or UE to determine a load balancing command for at least one access network node, the load balancing command including at least one data item from a group of: i) a power parameter; ii) a measurement configuration; iii) a handover decision configuration; and iv) a UE handover decision. The power parameter may be a cell, SSB beam or site power parameter. The measurement configuration may be for a UE and defines the circumstances that cause the UE to send a measurement report to the access network node. The handover configuration decision may define at least one condition required to cause the at least one access network node to trigger a handover of a UE to a neighbouring cell. For example, the at least one condition comprises at least one of: i) a number of measurement events signalled by a UE before triggering handover of that UE to a neighbouring cell, and ii) a time elapsed after a measurement event before handover of the UE is triggered.

In some example embodiments, the UE handover decision identifies at least one UE that is served by the at least one access network node and a target cell to which the at least one UE is to be handed over.

According to another aspect, there is provided an access network node of a communication network, the access network node comprising: means for sending to another node of the communication network, input data including at least one data item from a group of: i) at least one Synchronisation Signal Block, SSB, index of an SSB that overlaps with a cell of another node and a number of UE per the SSB that overlaps with the cell of the another node; ii) hardware load data indicating a hardware load of the access network node; iii) radio resource load data indicating a radio resource load of the access network node; and iv) purpose data indicating a purpose of a model to be trained or to be updated by the another node. The input data may be used for training a model for outputting at least one parameter for load balancing.

According to another aspect, there is provided an access network node comprising: means for receiving a model including a mapping table which associates a power of at least one Synchronisation Signal Block, SSB, of the access network node with a number of user equipment, UE, that provide at least one measurement report for at least one neighbouring access network node which is neighbour to the access network node; means for receiving input information from the at least one neighbouring access network node; and means for using the input information and the model to determine at least one load balancing action to be performed by the access network node, wherein the input information includes at least one data item from a group of: i) at least one Synchronisation Signal Block, SSB, index of an SSB that overlaps with a cell of each of the at least one neighbouring access network node and a number of UE per the SSB that overlaps with the cell of the each of the at least one neighbouring access network node; ii) hardware load data indicating a hardware load of the access network node; and iii) radio resource load data indicating a radio resource load of the access network node.

According to another aspect, there is provided a communication network comprising: means for receiving input data from at least one of a plurality of access network nodes; and means for using the input data from the at least one of the plurality of access network nodes and a model to determine at least one load prediction for the at least one of the plurality of access network nodes, wherein the at least one load prediction includes at least one data item from a group of: i) a total number of user equipment, UEs, that are served by the at least one access network node; ii) a number of UEs per Synchronisation Signal Block, SSB, of the at least one access network node; iii) a number of UEs that are served by the at least one access network node that will send a measurement report identifying a given neighbouring cell; and iv) a predicted Radio Resource Load for the at least one access network node. The input data may include at least one of: i) at least one SSB index of an SSB that overlaps with a cell of a neighbouring access network node which is neighbour to one of the at least one access network node and a number of UE per the SSB that overlaps with the cell of the neighbouring access network node; ii) hardware load data indicating a hardware load of the access network node; iii) radio resource load data indicating a radio resource load of the access network node; and iv) purpose data indicating a purpose of the model to be trained or to be updated.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of examples, with reference to the accompanying drawings in which:

FIG. 1 illustrates schematically a mobile (cellular or wireless) telecommunication system to which example embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 is a schematic diagram illustrating the interactions between nodes of a system, when using Artificial Intelligence/Machine Learning;

FIG. 6 is a schematic signalling (timing) diagram illustrating the interactions between nodes of the telecommunication system to balance the load in the system according to a first example embodiment;

FIG. 7 is a schematic diagram illustrating coverage areas of three cells operating on three different frequencies and illustrating an unbalanced load between the three cells;

FIG. 8 is a schematic diagram illustrating the coverage areas of the three cells operating on three different frequencies after load balancing;

FIG. 9 is a schematic diagram illustrating coverage areas of two cells operating on two different frequencies and illustrating an unbalanced load between the two cells;

FIG. 10 is a schematic diagram illustrating the interactions between nodes of a system, when using Artificial Intelligence/Machine Learning, according to a second example embodiment;

FIG. 11 is a schematic diagram illustrating overlapping coverage areas of six cells operating on six different frequencies;

FIG. 12 is a schematic diagram illustrating the interactions between nodes of a system, when using Artificial Intelligence/Machine Learning, according to a third example embodiment; and

FIG. 13 is a schematic diagram illustrating the interactions between nodes of a system, when using Artificial Intelligence/Machine Learning, according to a fourth example embodiment.

### DESCRIPTION OF EMBODIMENTS

### Overview

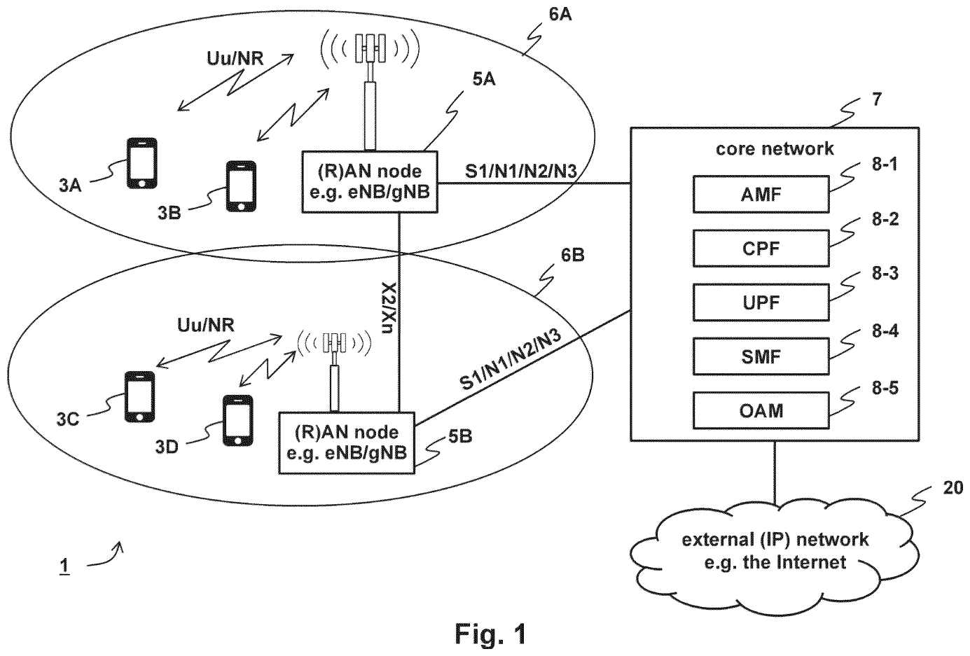

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes and mobile devices (UEs).

Each base station 5 controls one or more associated cells 6 (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 8-2 and one or more user plane functions (UPFs) 8-3. The core network 7 will also include the so-called Access and Mobility Management Function (AMF) 8-1 in 5G, or the Mobility Management Entity (MME) in 4G, that is responsible for handling connection and mobility management tasks for the mobile devices 3. The Session Management Function (SMF) 8-4 that is responsible for handling communication sessions for the mobile devices 3 such as session establishment, modification and release. The Operations, Administration and Maintenance (OAM) function 8-5 may be implemented in software in one or more 5G CN nodes. The core network 7 is coupled to a data network 20, such as the Internet or a similar Internet Protocol (IP) based network.

### User Equipment (UE)

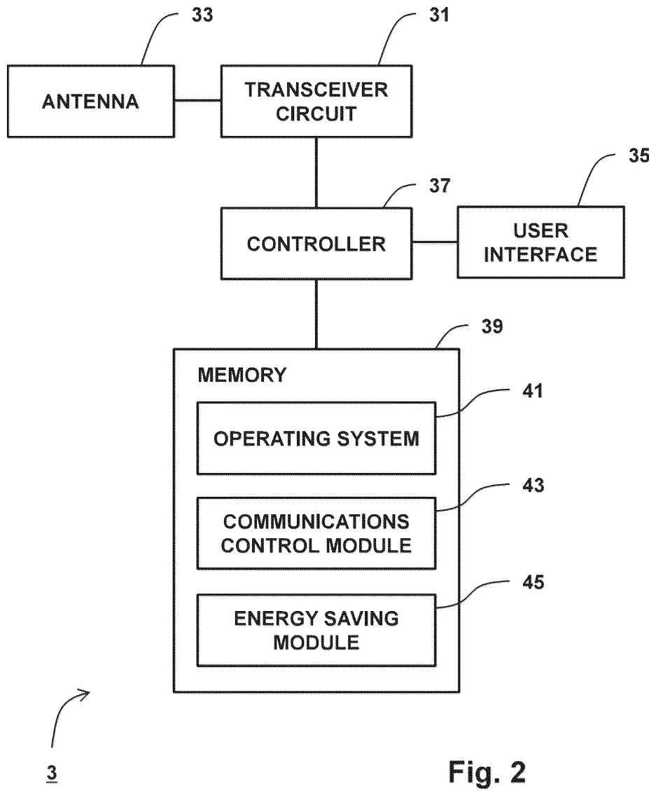

FIG. 2 is a block diagram illustrating the main components of a mobile device (UE) 3 shown in FIG. 1. As shown, the UE 3 includes a transceiver circuit 31 which is operable to transmit signals to and to receive signals from the one or more connected nodes via one or more antennas 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an energy saving module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling, (e.g. via system information or RRC) related to the energy saving operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The energy saving module 45 is responsible for operations relating to energy saving (by the UE 3 itself and/or by network nodes such as the access network node/base station 5). Energy saving by the UE itself is typically achieved by turning off certain components (e.g. the transceiver circuit 31) for certain periods of time. As will be explained in more detail below, in the following example embodiments, the UE 3 can assist the network perform energy saving by taking various actions that help the network to obtain a more accurate picture of the actual load currently on the network.

### Access Network Node (Base Station)

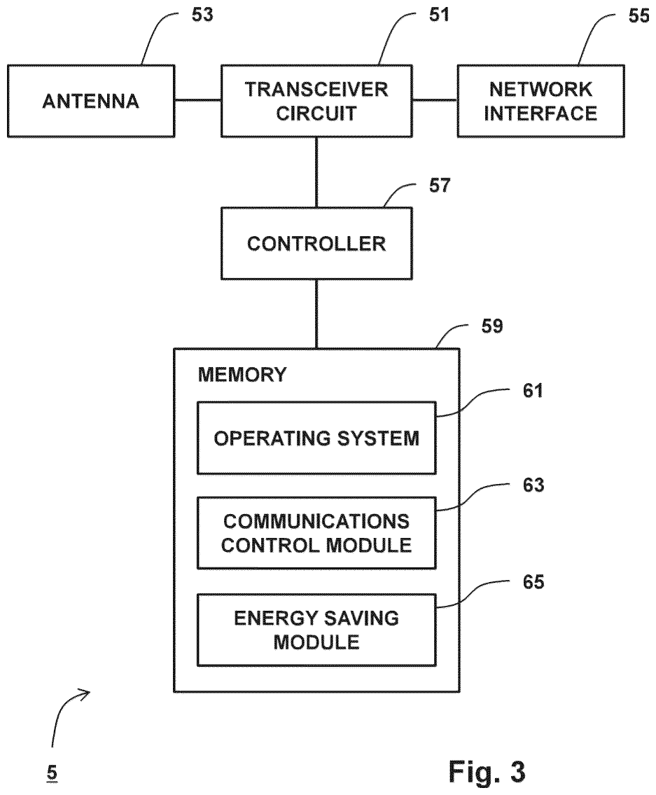

FIG. 3 is a block diagram illustrating the main components of the base station 5 (or a similar access network node) shown in FIG. 1. As shown, the base station 5 includes a transceiver circuit 51 which is operable to transmit signals to and to receive signals from at least one connected UE 3 via one or more antennas 53 and to transmit signals to and to receive signals from other network nodes (either directly or indirectly) via a network interface 55. The network interface 55 typically includes an appropriate base station to base station interface (such as an X2/Xn interface), and an appropriate base station to core network interface (such as an S1/N1/N2/N3 interface). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an energy saving module 65.

The communications control module 63 is responsible for handling (generating/sending/receiving) signalling between the base station 5 and other nodes, such as the UE 3 and the core network nodes. The signalling may comprise control signalling (e.g. via system information or RRC) related to the energy saving operation. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The energy saving module 65 is responsible for operations relating to energy saving (by the UE 3 and/or by the access network node/base station 5 itself). Energy saving is typically achieved by turning off certain components (e.g. the transceiver circuit 51) for certain periods of time.

### Core Network Function

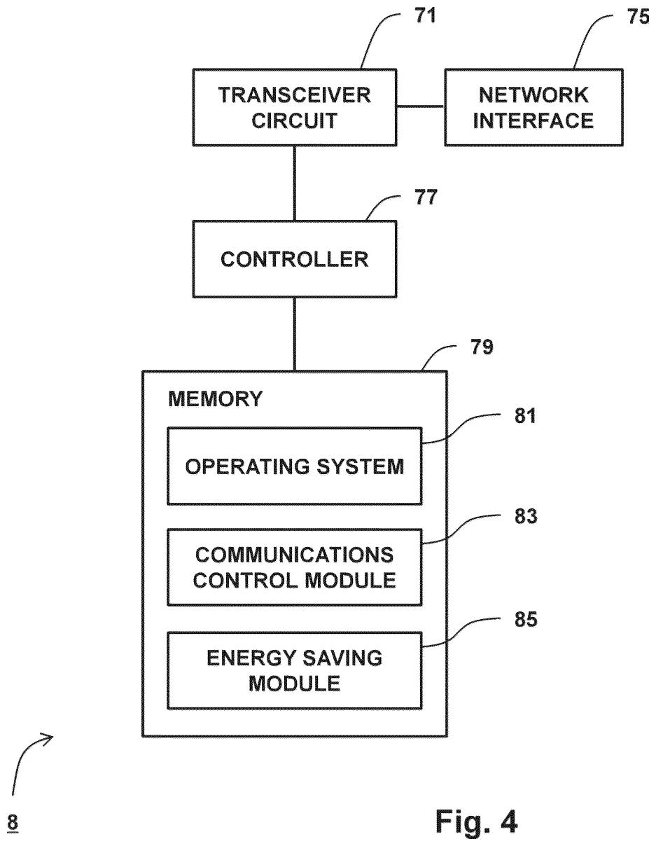

FIG. 4 is a block diagram illustrating the main components of a generic core network node or function 8, such as the AMF 8-1, CPF 8-2, the UPF 8-3, the SMF 8-4 or the OAM 8-5 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an energy saving module 85 (which may be optional).

The communications control module 83 is responsible for handling (generating/sending/receiving) signalling between the core network function and other nodes, such as the UE 3, the base station 5, and other core network nodes. The signalling may include for example a UE context/UE capability indication of a UE 3 related to energy saving.

If present, the energy saving module 85 is responsible for operations relating to energy saving (e.g. by the UE 3 and/or by the access network node/base station 5).

### Artificial Intelligence (AI)/Machine Learning (ML)

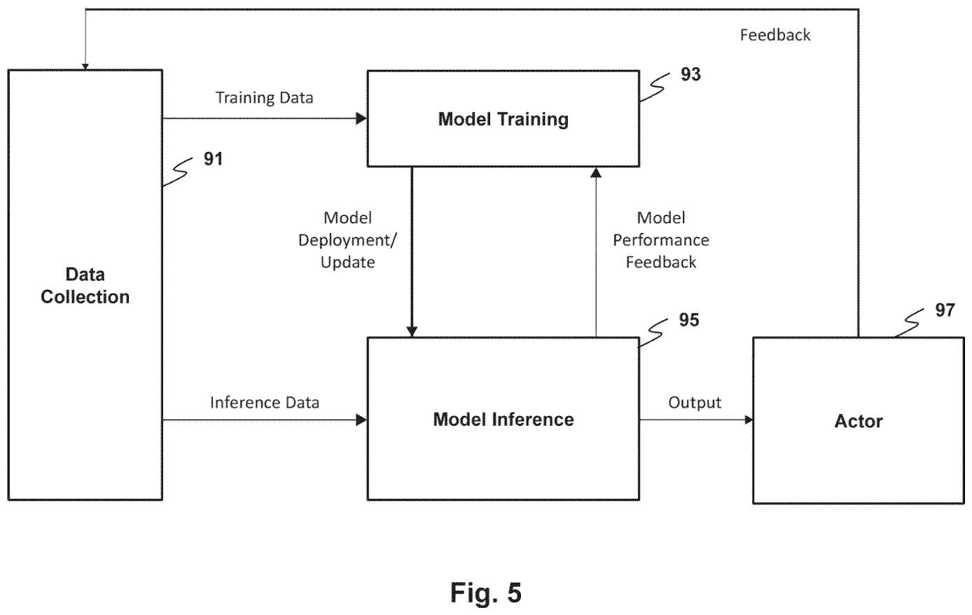

3GPP have proposed a functional framework in respect of AI/ML, and how various entities of the telecommunications system are to interact with one another in the context of this framework. In this regard, reference is now made to FIG. 5, which illustrates these entities.

The entities involved relate to a data collection function 91, a model training function 93, a model inference function 95, and actor 97. The data collection function 91 provides input data (training data) to the model training function 93 and the model inference function 95. The model training function 93 performs the ML model training, validation, and testing which may generate model performance metrics as part of a model testing procedure. The model inference function 95 provides AI/ML model inference output (e.g., predictions or decisions), and the actor 97 is a function or node that receives the output from the model inference function 95 and triggers or performs corresponding actions (e.g. an (radio) access network node which increases/reduces its transmit power to effect load balancing).

Terms referred to by 3GPP in the context of this framework include:

AI/ML Model: A data driven algorithm by applying machine learning techniques that generates a set of outputs including predicted information and/or decision parameters, based on a set of inputs.

AI/ML Training: An online or offline process to train an AI/ML model by learning features and patterns that best present data and get the trained AI/ML model for inference.

AI/ML Inference: A process of using a trained AI/ML model to make a prediction or guide the decision based on collected data and AI/ML model.

Training Data: Data needed as input for the AI/ML Model Training function. Inference Data: Data needed as input for the AI/ML Model Inference function.

Model Deployment/Update: Used to initially deploy a trained, validated, and tested AI/ML model to the Model Inference function or to deliver an updated model to the Model Inference function.

### DETAILED DESCRIPTION

The following is a description of how network loads may be determined, using AI/ML, thereby allowing the network to make better load balancing decisions within the system 1 shown in FIG. 1.

A first example embodiment to determine network load information and take appropriate further actions locates the model inference function 95 within a base station, such as within a (R)AN node, e.g. a gNB, or within a control unit of a gNB (gNB-CU) whilst the model training function 93 is located within a core network node 7 such as within the OAM 8-5. Beneficially, locating the model inference function 95 at the base station 5 allows rapid decisions to be taken in respect of adjusting the load of the network across cells as appropriate.

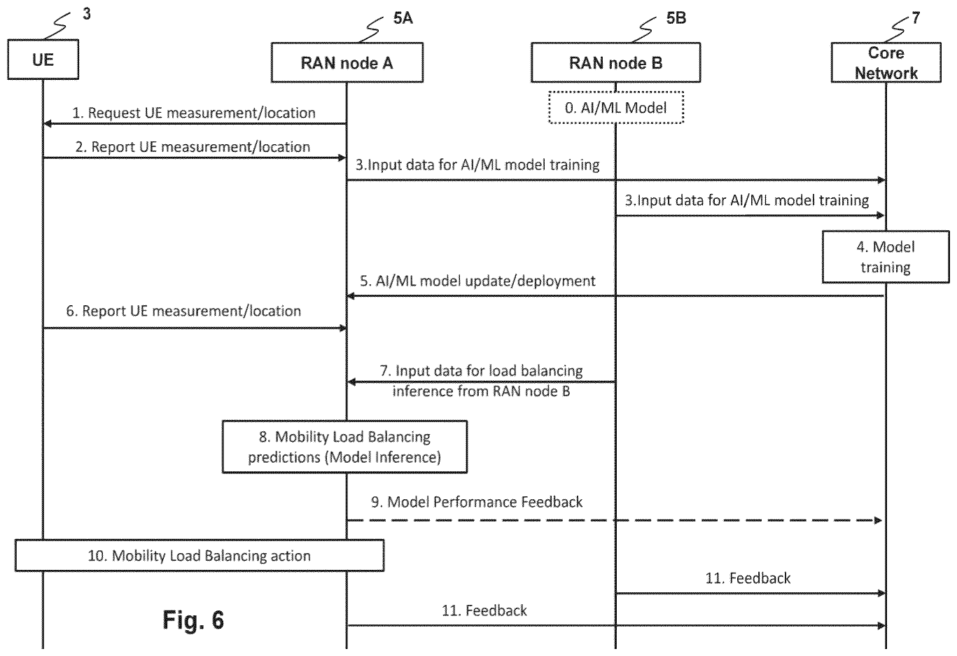

A more detailed description of the first example embodiment will now be described with reference to the signalling diagram shown in FIG. 6.

In overview, FIG. 6 illustrates the communications which occur between a UE 3, a base station (RAN node 5A) serving the UE 3, another neighbouring base station (RAN node 5B), and a core network 7 node (such as the OAM 8-5 function of the core network 7), in the context of load balancing using AI/ML. Before considering this signalling in more detail, step 0 indicates that RAN node 5B may optionally comprise its own AI/ML model, which can provide RAN node 5A with useful input information (discussed in more detail below), such as its predicted resource status, etc., as needed during the load balancing procedure.

In step 1, RAN node 5A signals a request to the UE 3 that the UE 3 is to report measurement and/or location information (e.g., radio resource management (RRM) measurements, reference signal received power (RSRP), reference signal received quality (RSRQ), signal to interference plus noise ratio (SINR) of the UE's serving cell and of neighbouring cells, minimisation of drive tests (MDT) measurements data, the UE's velocity information, the UE's positional information (e.g. GPS data), etc.). Whilst only one UE 3 is referred to in FIG. 6 and the associated description which follows, it will be appreciated that, in practice, multiple UEs will be signalled by the RAN node 5A in step 1 and that the RAN node 5A will receive corresponding measurement reports from each of these UEs. Moreover, the RAN node 5A may be configured to operate more than one cell, and therefore the RAN node 5A may make such requests across all or some of the cells it operates.

Then, in step 2, the UE 3 collects the requested measurement and/or location information and reports the collected information to RAN node 5A. The RAN node 5A then signals, in step 3, the received UE measurement reports as input data for AI/ML model training to the model training function 93 located in the core network 7 (e.g. at the core network's OAM function), together with other input data such as the hardware load at RAN node 5A, radio resource load at RAN node 5A, an indication of AI/ML purpose (e.g., for load balancing, mobility robustness, (network) energy saving, or the like). The radio resource load may be represented by the usage of physical resource blocks, PRBs, in the serving cell of RAN node 5A, and the hardware load and the radio resource load may be a filtered average load within a past time period (e.g., within the last 30, 60, etc. seconds, or an alternative period of time as appropriate). Additionally, the hardware load and radio resource load signalled in step 3 may be represented by descriptors which can be mutually interpreted by the receiving entity, such as “high, medium, low”, or as a given percentage of available capacity “10%, 20%, 30%”, etc.

Furthermore, RAN node 5B may also send its own input data for model training to the core network in step 3. In this regard, it should be appreciated that either, or both, of RAN nodes 5A and 5B will keep sending their respective input data to the core network 7 either at regular intervals or when more measurement data is available or when there is a change in their loading. In this way, the model can be better calibrated by the model training function 93 with each iteration of the process (as set out in the subsequent steps discussed below), beneficially resulting in a model which provides predictions/decisions with greater accuracy.

As illustrated in step 4, the AI/ML Model Training function 93, located in the core network 7, processes the input data signalled in step 3 to train the AI/ML model. The AI/ML model is trained using conventional machine learning training techniques that will not be described here.

The core network 7, having trained the AI/ML model, updates in step 5 the AI/ML model locally stored at the RAN node 5A (or deploys the AI/ML model to the RAN node 5A, if a model is not already locally stored in the RAN node 5A). The model includes a mapping table, which associates the power of each Synchronisation Signal Block, SSB, sometimes referred to as a Synchronisation Signal/Physical Broadcast Channel block (SS/PBCH block), with the number of user equipment which report a measurement report of each neighbour cell/frequency (examples of two such mapping tables are discussed below).

In step 6, the UEs in the cell continue to transmit their measurement reports, to RAN node 5A and in step 7 RAN node 5A receives, from the neighbouring RAN node B, input information that the AI/ML model stored in RAN node 5A can use to make its load balancing inference. This input information may include, the SSB index, number of UEs per SSB, hardware load, radio resource load (PRB utilization per SSB/per cell, etc.) of RAN node 5B. Using the up-to-date information received from the UEs 3 in step 6 and the current load information received from the neighbouring RAN node 5B in step 7, accurate mobility load balancing predictions may be made in step 8, using the RAN node 5A's model inference 95.

A first exemplary mapping table included in the model signalled in step 5 configures the RAN node 5A's Synchronisation Signal Block power in respect of a cell it operates (i.e., a serving cell), such that the RAN node 5A can calibrate its own serving cell SSB power depending on the load balancing to be achieved. A part of this mapping table is illustrated below and its use will be explained in detail in the following:

| | Neighbour | Neighbour cell | Load: | |
|---|---|---|---|---|
| MeasObjectNR | cell UE | load (may be | 1) Number of UE, | Serving cell |
| of serving | measurement | more than one | 2) PRB usage, and | SSB Power |
| cell | reported | neighbour cell) | 3) hardware load | configuration |
| SSB1 | SSB4 of Cell 1 | 20-all UE of | 1) 1-10, | −24 dBm |
| | | neighbour SSB4 | 2) 0-20%, | |
| | | | 3) 0-20% | |
| SSB1 | SSB4 of Cell 1 | 10-20 UE of | 1) 10-20, | −25 dBm |
| | | neighbour SSB4 | 2) 20-40%, | |
| | | | 3) 20-40% | |
| SSB1 | SSB4 of Cell 1 | 0-10 UE of | 1) 20-all, | −26 dBm |
| | | neighbour SSB4 | 2) 40% or above, | |
| | | | 3) 40% or above | |
| SSB2 | SSB3 of Cell 2 | 20-all UE of | 1) 1-10, | −24 dBm |
| | | neighbour SSB3 | 2) 0-20%, | |
| | | | 3) 0-20% | |
| SSB2 | SSB3 of Cell 2 | 10-20 UE of | 1) 10-20, | −25 dBm |
| | | neighbour SSB3 | 2) 20-40%, | |
| | | | 3) 20-40% | |
| SSB2 | SSB3 of Cell 2 | 0-10 UE of | 1) 20-all, | −26 dBm |
| | | neighbour SSB3 | 2) 40% or above, | |
| | | | 3) 40% or above | |

RAN node 5A knows which UEs it is serving are on which of its SSBs. The UE 3 reports that RAN node 5A receives in step 6 from the UEs it is serving, can therefore be broken down into reports per SSB. The base stations 5 also know which of its SSBs point to which neighbouring cells. So, if RAN node 5A knows that 8 UEs are on its SSB1, then it can look at the measurement reports from those 8 UEs. In this example, these reports identify that these UEs are also able to see and have reported on neighbouring cell 1 that in this example is operated by RAN node 5B.

RAN node 5A can therefore look at the load information received from RAN node 5B to determine the load of this neighbouring base station. Specifically, RAN node 5B knows that its SSB4 beam is pointed towards the cell operated by RAN node 5A. Therefore, when RAN node 5B reports its loading to RAN node 5A, it identifies the number of UE it is currently serving using its SSB4—as this is the beam that UEs that might be handed over from RAN node 5A would move to in cell 1 of neighbouring base station RAN node 5B. Similarly, if RAN node 5B also has a similar model inference, then RAN node 5A knows that its SSB1 is pointing towards cell 1 of RAN node 5B and so when it reports its loading to RAN node 5B it does so in respect of its SSB1—as this is the SSB to which UEs would be handed over if they moved from RAN node 5B to RAN node 5A. Depending on the difference between the load of neighbouring SSB4 and the load on SSB1 of the serving cell, RAN node 5A can increase or decrease the transmission power of SSB1 accordingly using the above table. For example, if the neighbouring RAN node 5B reports that there are 30 UEs being served by its SSB4 and SSB1 of the serving cell has 8 UEs that have reported seeing cell 1 of RAN node 5B, and the PRB usage in RAN node 5A is 15% and the hardware load is 18%, then a high transmit power for SSB1 can be set or maintained (for example of −24 dBm—as per row 1 of the above table) because the neighbouring SSB4 is already more heavily loaded than SSB1. However, if neighbouring base station 5B reports that it has just 5 UEs on SSB4 and there are 25 UEs currently being served by SSB1 that have reported on seeing cell 1 of the RAN node 5B and the PRB usage of SSB1 and the hardware load of RAN node 5A are both above 40%, then RAN node 5A will reduce its transmit power (for example to −26 dBm) on SSB1 to cause some of the UEs it is serving on SSB1 to move over to SSB4 of neighbouring base station 5B. If RAN node 5B has provided information about its own hardware load and/or resource load, then RAN node 5A may also compare this loading information to its own hardware and PRB loading information to decide on the transmit power of its SSB1.

Assuming that the neighbouring base stations 5 are also running similar AI/ML inference functions 95, RAN node 5A will report its loading information to those neighbouring base stations. For example, RAN node 5A knows that its SSB1 beam is pointed towards cell 1 of RAN node 5B (because of the measurement reports it receives), so it may report the loading on its SSB1 to RAN node 5B. In this way, the neighbouring base stations can take corresponding actions. So, for example, if RAN node 5A increases the transmit power on its SSB1, then RAN node 5B may decrease the transmit power on its SSB4. In this way, the load will be balanced between the neighbouring base stations. In addition, it is possible that multiple SSBs of RAN node 5B may point towards the serving cell of RAN node 5A. In this case, RAN node 5B will report the loading on all of those SSBs and RAN node 5A will consider the loading on its SSB1 in comparison to the loading on those other SSBs of RAN node 5B when making the decision on the transmit power of SSB1.

The above description has considered the situation between two neighbouring base stations. Clearly, the same actions can be performed in respect of all the neighbouring cells, but instead of varying the transmit power of SSB1, RAN node 5A will vary the transmit power of the relevant SSB that points towards the corresponding neighbouring cell. So, for example, from the above table we can see that SSB2 of RAN node 5A points towards neighbouring cell 2 of a neighbouring base station. That base station's SSB3 points towards RAN node 5A and so it reports on how many UEs are on its SSB3—so that RAN node 5A can make a similar decision about the transmit power of its SSB2—as shown in the table above. If the neighbouring base station that operates cell 2 also has a similar AI/ML model, then RAN node 5A can report the number of UEs on its SSB2 to that neighbouring base station so that it can perform a corresponding load balancing decision. Although not shown, the table will have similar entries for each SSB of RAN node 5A.

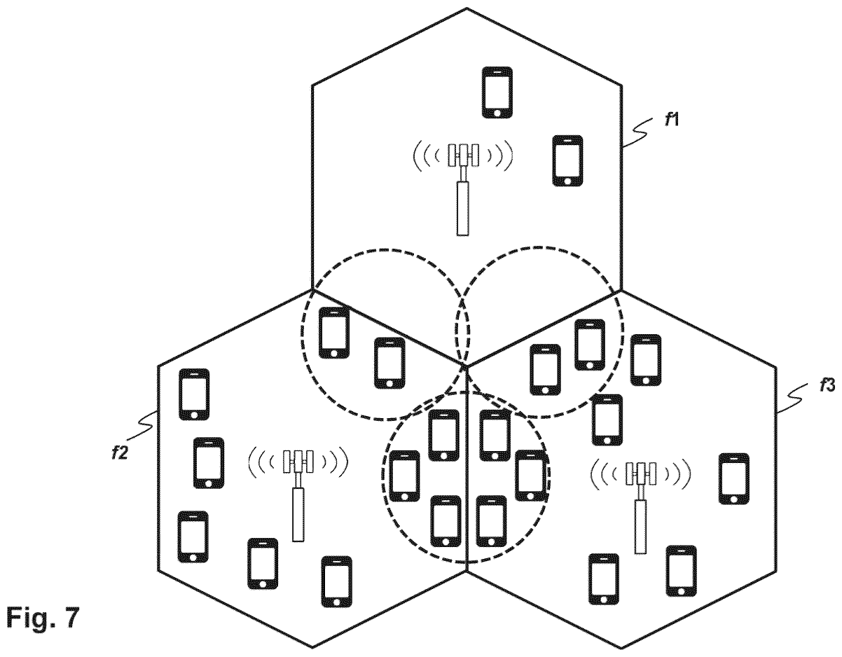

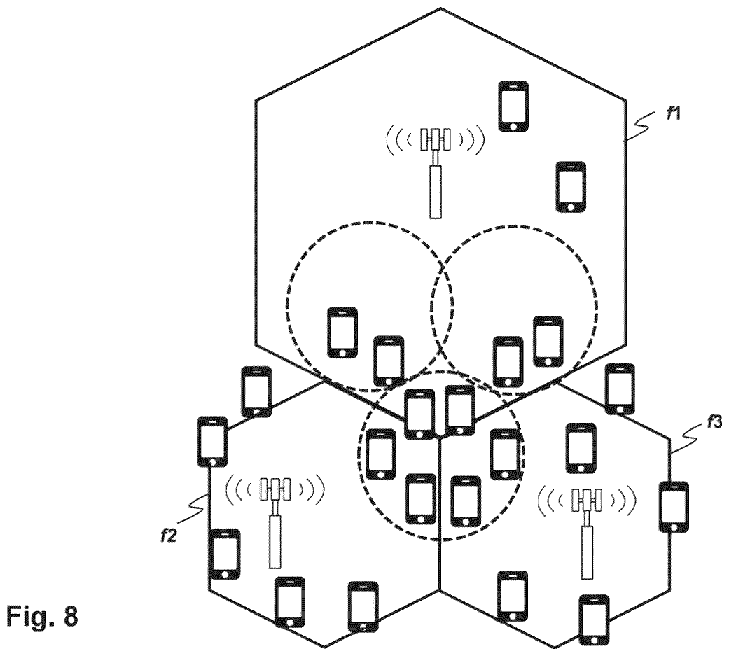

Reference is now made to FIGS. 7 and 8 which illustrate the impacts of such load balancing in a telecommunications system. FIG. 7 illustrates the cell being operated by RAN node 5A (the cell being operated on a first frequency, f1), the cell being operated by RAN node 5B (the cell being operated on a different second frequency, f2), and a cell being operated by further RAN node (this cell being operated by a third RAN node on another, third frequency, f3), before any load balancing operations are performed. Cell f1 serves two UEs, whereas cells f2 and f3 each serve ten UEs. As is also illustrated, with dashed circles, there are three overlapping areas of coverage between:
A) cells f1 and f2 (two UEs are in this overlapping coverage area—the overlap may be formed by one or more SSBs of cells f1 and f2 overlapping with each other);
B) cells f1 and f3 (two UEs are also in this overlapping coverage area—the overlap may be formed by one or more SSBs of cells f1 and f3 overlapping with each other), and
C) cells f2 and f3 (six UEs are in this overlapping coverage area—the overlap may be formed by one or more SSBs of cells f2 and f3 overlapping with each other).

Accordingly, it can be appreciated that cells f2 and f3 are overloaded with UEs relative to cell f1. Consequently, based on the sequence of signalling illustrated in FIG. 6, RAN node 5A operating cell f1 can perform a load balancing prediction, which predicts that it will receive, via handover, several UEs from cells f2 and f3 if it increases its coverage area such that UEs in the overlapping coverage area handover to cell f1, and in response decide to increase its coverage area (by increasing the transmit power) thereby causing the UEs to handover from the overloaded cells f2 and f3, as illustrated in FIG. 8. At the same time, the RAN nodes operating cells f2 and f3 will decrease their coverage area (by reducing their transmit powers), thereby ensuring that the UEs which they previously served handover to cell f1 (which, as a consequence in the change of transmission powers, will have a much greater RSRP for those UEs at the cell edge than the RSRP of cells f2 and f3).

Returning to the timing diagram shown in FIG. 6, in step 8, e.g. in the situation illustrated in FIG. 7, the RAN node 5A can execute accurate load balancing predictions for its own cell (or its own cells, depending on the deployment of RAN node 5A) based on the up-to-date information processed by the model inference 95. Optionally, in step 9, RAN node 5A may send model performance feedback to the core network 7, if appropriate.

Once the prediction has been made by the model inference, the RAN node 5A executes, in step 10, mobility load balancing actions in accordance with the predictions made by the model inference (e.g. the situation illustrated in FIG. 8). Consequently, some UE may be moved (handed over) between the serving cell of RAN node 5A and a cell of neighbouring RAN node 5B (or other neighbouring cells, as appropriate) to balance the load across the cells operated by these nodes.

Once one or more handovers of at least one UE between the respective cells of RAN nodes 5A and 5B (or the one or more other cells) have occurred, each RAN node 5A, 5B then feeds back to the core network 7 in step 11, feedback information in respect of the change, e.g., information about the loads now experienced by each respective RAN node 5A, 5B (which ought to be more equal than before the change was implemented).

In the example embodiment above, the model inference located at RAN node 5A used a mapping table to adapt the transmit powers of the SSBs broadcast by RAN node 5A to achieve a desired load balancing operation. Instead of varying the transmit powers, the base station may vary handover decision parameters that are used to control the handover of UEs that are being served by RAN node 5A to other neighbouring RAN nodes (or, instead, the trained model may indicate modifications to both of the SSB power and the handover parameters of RAN node 5A at the same time using both mapping tables). An example of a mapping table that could be used in such an example embodiment is provided below:

| | | | | Handover decision |
|---|---|---|---|---|
| | | | | parameters: |
| | | | | 1: Number of measurement |
| | | Load: | | events to trigger handover |
| Serving | Neighbour cell | 1) Number of UE, | Measurement | 2: time elapsed after |
| cell SSB | UE measurement | 2) PRB usage, and | parameter | measurement events reported |
| Power | reported | 3) Hardware load | configuration | to trigger handover |
| −24 dBm | Cell 1 | 1. 1-10, | MeasConfig1 | 1. 3 |
| | | 2. 0-20%, | | 2. 100 ms |
| | | 3. 0-20% | | |
| −25 dBm | Cell 1 | 1. 10-20, | MeasConfig2 | 1. 5 |
| | | 2. 20-40%, | | 2. 200 ms |
| | | 3. 20-40% | | |
| −26 dBm | Cell 1 | 1. 20-all, | MeasConfig3 | 1. 4 |
| | | 2. 40% or above, | | 2. 50 ms |
| | | 3. 40% or above | | |
| −24 dBm | Cell 2 | 1. 1-10, | MeasConfig4 | 1. 3 |
| | | 2. 0-20%, | | 2. 100 ms |
| | | 3. 0-20% | | |
| −25 dBm | Cell 2 | 1. 10-20, | MeasConfig5 | 1. 5 |
| | | 2. 20-40%, | | 2. 200 ms |
| | | 3. 20-40% | | |
| −26 dBm | Cell 2 | 1. 20-all, | MeasConfig6 | 1. 4 |
| | | 2. 40% of above, | | 2. 50 ms |
| | | 3. 40% or above | | |

For example, referring to the first row of the table, if the serving cell (i.e. RAN node 5A) has its SSB power configured as −24 dB, and ten UEs served by RAN node 5A have reported that their neighbouring cell is cell 1 (e.g. a cell formed by RAN node 5B), and the neighbouring cell's hardware load is 10% and its PRB usage is 10%, then the serving cell re-configures the UE 3's measurement configuration, i.e., the circumstances in which the UE 3 should trigger its measurement reporting, to measurement parameter configuration (MeasConfig1). Each MeasConfig IE (transmitted to UE 3 via signalling not explicitly shown in step 10 of FIG. 6) defines a threshold that, once met, results in UE 3 reporting its RSRP/RSRP as a consequence of one the following configured events being triggered:
Event A1 (Serving cell becomes better than threshold);
Event A2 (Serving cell becomes worse than threshold);
Event A3 (Neighbour cell becomes offset better than SpCell);
Event A4 (Neighbour cell becomes better than threshold); and
Event A5 (SpCell (special cell) becomes worse than threshold1 and neighbour cell becomes better than threshold2).

Additionally, the model inference 6 outputs to the RAN node 5A updated handover decision parameters in respect of the number of measurement event configurations needed to trigger handover (in this example, 3 events), as well as the time elapsed after the measurement events were signalled to triggering that handover (in this example, 100 milliseconds).

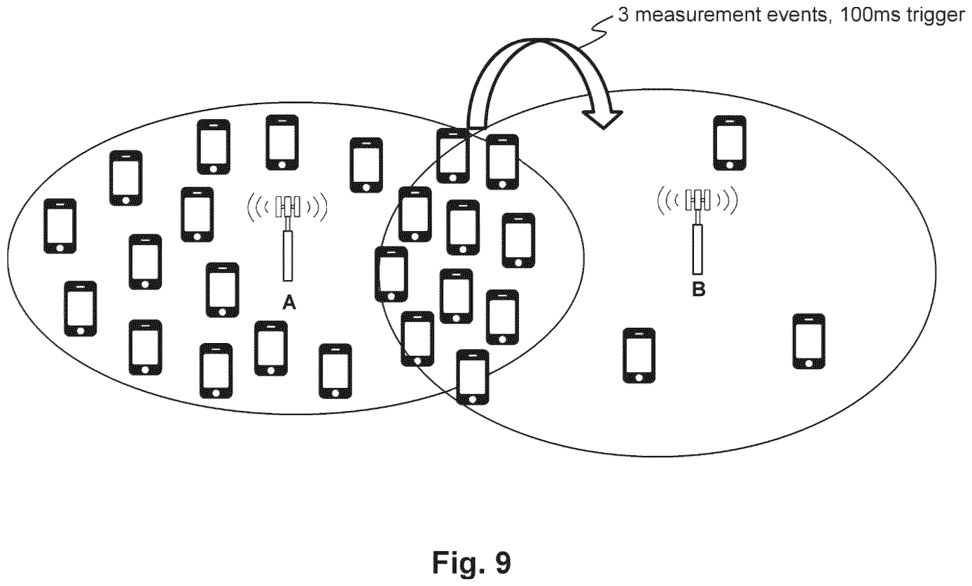

FIG. 9 illustrates the scenario described above with respect to the first row. In this example, the cell formed by base station A (having a −24 dB SSB power) currently serves 23 UEs, whilst cell 1 (formed by RAN node 5B) only serves 3 UEs. Provided RAN node 5B's hardware load is 10% and its PRB usage is 10%, RAN node 5A will apply the parameters of MeasConfig1 such that the UEs which can handover to RAN node 5B (i.e. the ten UEs which reported they received signalling from cell 1 formed by RAN node 5B) are handed over to RAN node 5B 100 milliseconds after the third measurement event was signalled. Consequently, the load between the cells will be balanced, and both cells will serve 13 UEs each once the handover from RAN node A to RAN node B is completed.

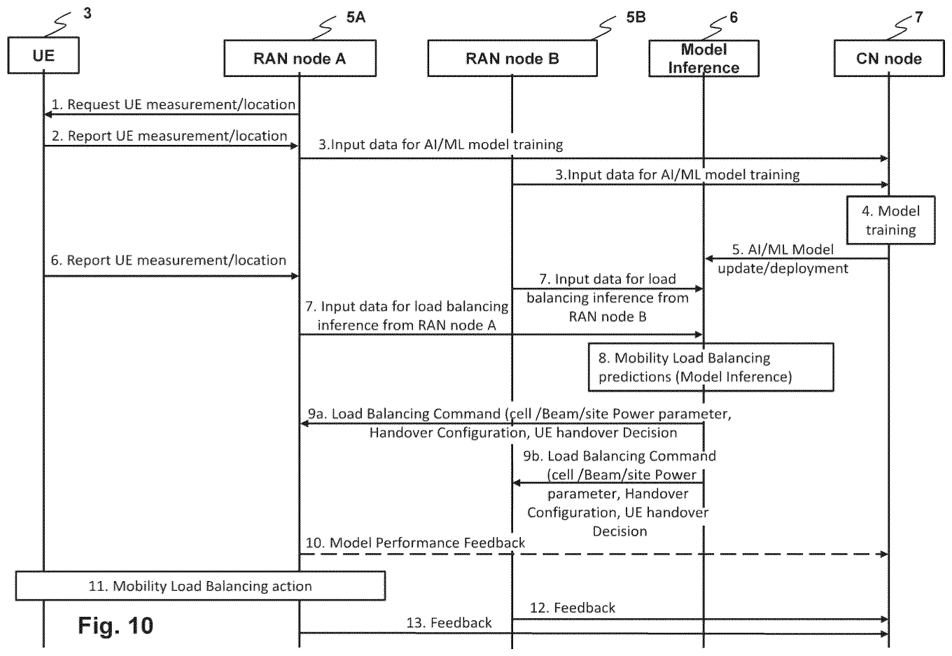

In the example embodiments described above with reference to FIGS. 6 to 9, the AI/ML model inference 95 balanced the loads between cells by calculating an appropriate SSB power, and by adapting handover decision parameters, in the case where the model inference 95 is located in a RAN node and the model training function 93 is located in the core network. In the following second example embodiment, described with reference to FIG. 10, the AI/ML model inference 95 is instead located in a separate node (rather than the RAN node 5A/5B etc.). In this example embodiment, as in the former, the model training function 93 is located in the core network 7.

Referring now to FIG. 10, steps 1 to 6 of this example embodiment are substantially the same as steps 1 to 6 of the first example embodiment illustrated in FIG. 6, and therefore will not be repeated here, save that in step 5 of the present example embodiment the AI/ML model is deployed/updated by the core network 7 at the model inference node 6 (rather than at the RAN node 5A as in the prior example embodiment). Continuing in step 7, both RAN node 5A and RAN node 5B send their respective input data for load balancing to the model inference node 6. The input data is the same as that provided in the example embodiments described above. Then, in step 8, the Mobility and Load Balancing prediction is carried out in Model Inference node 6, which determines a prediction of what the load in each base station will be in a coming period of time.

In steps 9a and 9b, the model inference node 6 uses the predicted loads to determine and send a respective Load Balancing Command to RAN node 5A and to RAN node 5B, that causes the base stations to take the appropriate load balancing action. The command may have one or more of the following parameters: at least one power parameter, measurement configuration, handover decision configuration, UE handover decision. The at least one power parameter may define the cell transmit power, the SSB beam power for each SSB and/or the overall site power for the base station. Like in the earlier example embodiment, the measurement configuration may define for each UE, for each UE in a given SSB or for all UEs served by the base station, what circumstances should trigger the UE into sending a measurement report. Like in the earlier example embodiment, the UE handover decision parameter defines the circumstances when the base station should trigger handover for a UE. Thus, the handover decision parameters may define the number of measurement events to trigger handover and the time elapsed after measurement events reported to trigger the handover. The UE handover decision parameter may identify one or more UEs that should be handed over to another base station. This parameter will identify which UEs should be handed over and the target cell for each of those UEs.

Finally, steps 10 to 13 of this example embodiment are respectively the same as steps 9 to 11 of the first example embodiment illustrated in FIG. 6, and will not be repeated here.

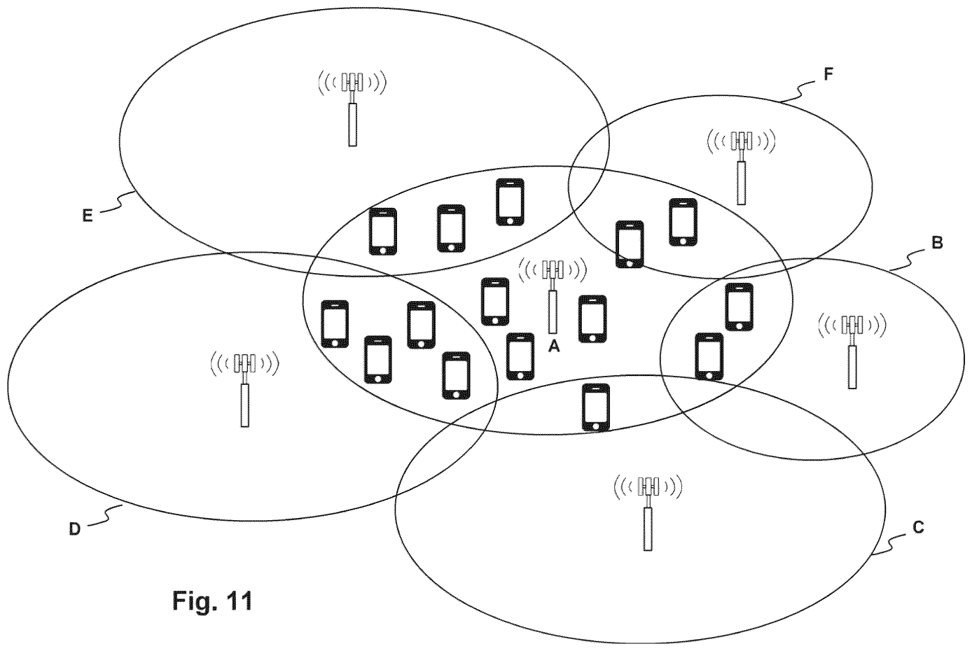

Reference is now made to FIG. 11, which illustrates the impacts of the above-described signalling of the second example embodiment on cells of a telecommunications system. As illustrated in FIG. 11, there are six cells operated by six RAN nodes (assume that cell A is operated by RAN node 5A described in FIG. 10). There are three UEs solely in the coverage of cell A, and a further twelve UEs both in the coverage in cell A and the coverage of another cell (two UEs are in coverage of cells A and B, one UE is in coverage of cells A and C, four UEs are in coverage of cells A and D, three UEs are in coverage of cells A and E, and two UEs are in coverage of cells A and F).

Accordingly, two UEs can handover to cell B, one UE can handover to cell C, four UEs can handover to cell D, three UEs can handover to cell E, and two UEs can handover to cell F (whilst 3 UEs do not have a candidate cell to handover to), provided that the target cell is not overloaded.

Following the procedure set out in FIG. 10 with respect to the scenario illustrated in FIG. 11, the core network 7 will deploy the AI/ML model to the model inference node 6 which predicts the loading in the different cells and determines which UEs can handover to which neighbouring cell. The model inference node 6 then transmits the respective load balancing commands to each of the base stations operating the cells A to F. In this way, RAN node 5A will be commanded by the model inference node 6 to change its operating parameters or to change its handover parameters or will be instructed to handover specific UEs to other cells, so that the load is more evenly balanced across the cells A to F.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

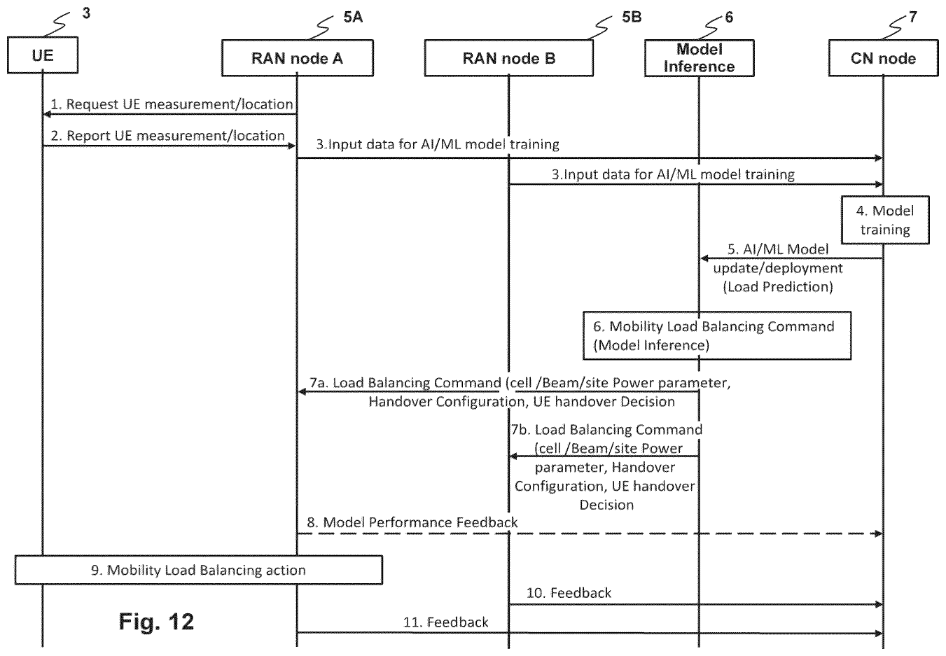

In the example embodiment described with reference to FIG. 10, the model inference node 6 predicted the load in each base station cell in step 8. However, the load may also or instead be predicted by the core network node 7 (such as by an OAM function) each time the model is updated using the input data supplied by the base stations. The model inference node 6 may then determine and send load balancing commands the base stations 5 as before. The timing diagram for such an example embodiment is illustrated in FIG. 12.

FIG. 12 broadly corresponds to the procedure illustrated in FIG. 10, and the corresponding steps will not be repeated here. In step 5, the core network node 7 predicts the load of RAN nodes 5A and 5B based on the input data it receives from these nodes in step 3. The load prediction message is sent to model inference 6, along with the trained (or updated) model. This load prediction message may comprise one or more of the following parameters:
Next Predicted Periodicity: 100 ms, 200 ms, 500 ms, 1 s, 5 s, 10 s, 30 s, 1 m, 5 m, etc.;
Next Predicted Load: the number of UE in total, within a given deviation, e.g. 200 UEs±30, and/or the number of UEs per SSB within a given deviation, e.g. 25 UEs±30;
Next Predicted Load with Neighbour Cell: the number of UE which report measurement of a given cell, within a certain deviation, e.g. 50 UEs=10. This parameter helps the serving cell determine which UEs can handover to which neighbour cell, such that the serving cell can balance the load by handover of at least one UE to one or more neighbour cells.
Next Predicted Radio Resource Load: PRB usage per cell/per SSB, within a given deviation, e.g., 40%±5%.

As a consequence of the core network node 7 performing the load prediction, the same prediction does not need to be performed by the model inference node 6 (i.e. steps 6 to 8 as shown in FIG. 10 are effectively skipped), and instead the model inference node 6 determines and sends appropriate load balancing commands in steps 7a and 7b to RAN node 5A and RAN node 5B, based on the predicted loads received from the core network node 7.

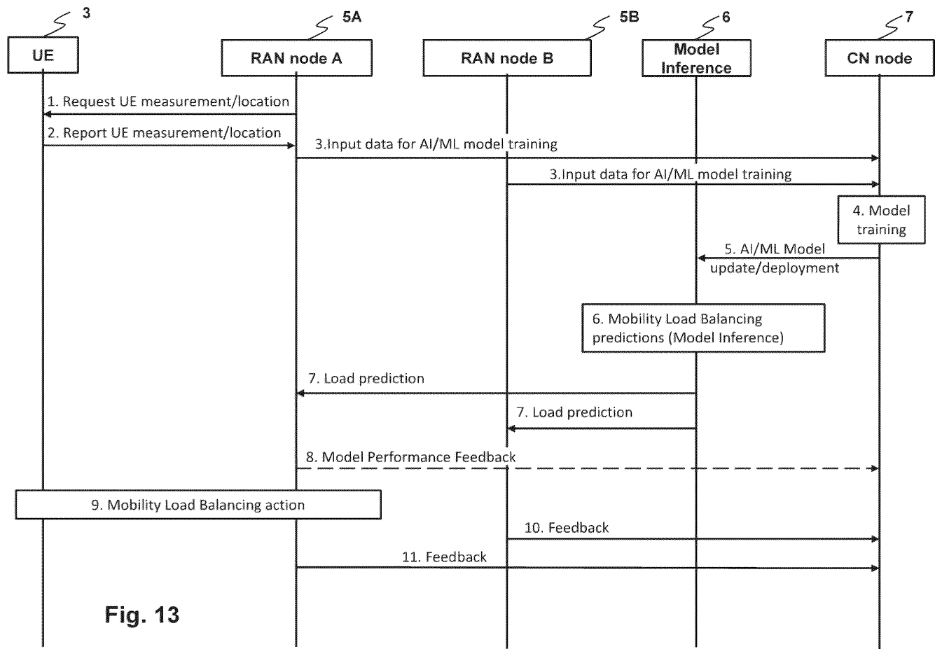

Further, once the load of each base station has been predicted (either by the core network node 7 or by the model inference node 6) instead of the model inference node 6 determining the load balancing commands, the predicted load information for the base stations 5 may be sent to the base stations 5 which then determine their own load balancing actions to take based on the predicted load imbalance between the base station and its neighbouring base stations. The timing diagram for such an example embodiment is illustrated in FIG. 13 which broadly corresponds to the procedure illustrated in FIG. 10, and the corresponding steps will not be repeated here.

In FIG. 13, instead of the core network 7 generating a load prediction and sending it to the model inference node 6, in this example the model inference node 6 generates the load prediction in step 6 and sends the load prediction message, including one or more of the parameters mentioned above in the description of FIG. 12, directly to RAN nodes 5A and 5B in step 7, such that these RAN nodes 5 can take their own load balancing actions to balance the load between them.

According to another alternative, each base station (RAN node 5) may send input data to the model training function and to the model inference function identifying for each SSB index, the number of UEs on that SSB, and at least one cell identifier of a neighbouring base station which overlaps with that SSB, which the model training function uses to train the model and which the model inference function uses to make predictions about the load in the network or to make load balancing decisions.

It will be appreciated that the above example embodiments may be applied to both 5G New Radio (5G NR) and LTE systems (E-UTRAN). The above example embodiments may also be applied to future systems (beyond 5G, 6G, etc.).

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above example embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time. A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: NPL 4, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note A1

A method performed by an access network node of a communication network, the method comprising:
receiving one or more user equipment, UE, measurement reports from one or more UEs served by the access network node; and
sending input data to a second node of the communication network, the input data including at least one data item selected from the group of:
i) at least one Synchronisation Signal Block, SSB, index of an SSB that overlaps with a cell of at least one neighbour access network node and a number of UEs on that SSB;
ii) hardware load data indicating a hardware load of the access network node;
iii) radio resource load data indicating a radio resource load of the access network node; and
iv) purpose data indicating a purpose of a model to be trained or to be updated by the second node.

### Supplementary Note A2

The method according to Supplementary Note A1, wherein the input data sent by the access network node includes the radio resource load data and indicates a usage of physical resource blocks, PRBs, by the access network node.

### Supplementary Note A3

The method according to Supplementary Note A1 or A2, wherein the input data sent by the access network node includes the hardware load data and wherein the hardware load data represents a filtered average load of the access network load over a past certain period.

### Supplementary Note A4

The method according to Supplementary Note A3, wherein the filtered average load is represented by a general load state descriptor or by a percentage of a predetermined load.

### Supplementary Note A5

The method according to any one of Supplementary Notes A1 to A4, wherein the input data sent by the access network node includes the radio resource load data and wherein the radio resource load data represents a filtered average load of the access network load over a past certain period.

### Supplementary Note A6

The method according to Supplementary Note A5, wherein the filtered average load is represented by a general load state descriptor or by a percentage of a predetermined load.

### Supplementary Note A7

The method according to any one of Supplementary Notes A1 to A6, wherein the input data sent by the access network node includes the purpose data which is one of Load Balancing, Mobility Robustness, Energy Saving.

### Supplementary Note A8

The method of any one of Supplementary Notes A1 to A7, wherein the sending sends the input data to a model training function or a model inference function.

### Supplementary Note A9

The method according to Supplementary Note A8, wherein the sending sends input data that includes at least one UE measurement report received from the one or more UEs served by the access network node.

### Supplementary Note A10

The method of any one of Supplementary Notes A1 to A9, wherein the sending sends the input data to a neighbouring access network node.

### Supplementary Note A11

A method performed by an access network node, the method comprising:
receiving a model from a model training function, the model comprising a mapping table which associates a power of at least one Synchronisation Signal Block, SSB, of the access network node with a number of User Equipment, UE, that provide a measurement report for at least one neighbour access network node;
receiving input information from the at least one neighbour access network node;
receiving one or more user equipment, UE, measurement reports from one or more UEs served by the access network node; and
using the input information from the at least one neighbour access network node, at least one of the UE measurement reports and the model to determine at least one load balancing action to be performed by the access network node.

### Supplementary Note A12

The method according to Supplementary Note A11, wherein the at least one action includes varying a transmit power of the at least one SSB.

### Supplementary Note A13

The method according to Supplementary Note A12, wherein the at least one action includes decreasing the transmit power of the at least one SSB if a loading on the SSB is greater than a loading on the at least one neighbouring access network node.

### Supplementary Note A14

The method according to Supplementary Note A12 or A13, wherein the at least one action includes increasing the transmit power of the at least one SSB if a loading on the at least one neighbouring access network node is greater than a loading on the at least one SSB.

### Supplementary Note A15

The method according to one of Supplementary Notes A11 to A14, wherein the at least one action includes changing at least one handover decision parameter used by the access network node to determine when to handover a UE to a neighbouring access network node.

### Supplementary Note A16

The method according to Supplementary Note A15, wherein the at least one action includes changing a number of measurement events that trigger handover of a UE to a neighbouring access network node.

### Supplementary Note A17

The method according to Supplementary Note A15 or A16, wherein the at least one action includes changing a time elapsed after measurement events are reported to trigger handover.

### Supplementary Note A18

The method according to any one of Supplementary Notes A11 to A17, wherein the at least one action includes changing a measurement parameter configuration for at least one UE and transmitting the changed measurement parameter configuration to the at least one UE.

### Supplementary Note A19

The method according to any one of Supplementary Notes A11 to A18, wherein the input information received from the at least one neighbour access network node includes at least one item selected from the group of: SSB index of an SSB that overlaps with a cell of the access network node and a number of UEs on this SSB, hardware load, radio resource load.

### Supplementary Note A20

The method according to any one of Supplementary Notes A11 to A19, further comprising transmitting input information relating to a load on the access network node to a neighbouring access network node for load balancing purposes, the input information including at least one item selected from the group of: SSB index of an SSB that overlaps with a cell of the neighbour cell and a number of UEs on this SSB, hardware load, radio resource load.

### Supplementary Note A21

A method performed in a communication network, the method comprising:
receiving input data from at least one of a plurality of access network nodes; and
using the input data from the at least one of a plurality of access network nodes and a model obtained from a model training function to determine at least one load prediction for at least one of the plurality of access network nodes, the load prediction including at least one data item selected from the group of:
i) a total number of User Equipment, UEs, that are served by the at least one access network node;
ii) a number of UEs per SSB of the at least one access network node;
iii) a number of UEs that are served by the at least one access network node that will send a measurement report identifying a given neighbouring cell; and
iv) a predicted Radio Resource Load for the at least one access network node.

### Supplementary Note A22

The method according to Supplementary Note A21, wherein at least one of the data items of the load prediction includes a deviation from the predicted number.

### Supplementary Note A23

The method according to Supplementary Note A21 or A22, wherein the at least one load prediction includes a predicted Radio Resource load for the at least one access network node that includes a Physical Resource Block usage per cell or per Synchronisation Signal Block, SSB.

### Supplementary Note A24

The method according to any one of Supplementary Notes A21 to A23, wherein the method is performed by a model inference node and the method further comprises receiving the model from the model training function.

### Supplementary Note A25

The method according to any one of Supplementary Notes A21 to A24, further comprising:
using the at least one load prediction to determine a load balancing command for at least one access network node, the load balancing command including at least one data item selected from the group of:
   i) a power parameter;
   ii) a measurement configuration;
   iii) a handover decision configuration; and
   iv) a UE handover decision.

### Supplementary Note A26

The method according to Supplementary Note A25, wherein the using the at least one load prediction to determine a load balancing command is performed by a model inference node or an access network node of the communication network.

### Supplementary Note A27

The method of Supplementary Note A25 or A26, wherein the power parameter is a cell, SSB beam or site power parameter.

### Supplementary Note A28

The method according to any one of Supplementary Notes A25 to A27, wherein the measurement configuration is for a UE and defines the circumstances that cause the UE to send a measurement report to the access network node.

### Supplementary Note A29

The method according to any one of Supplementary Notes A25 to A28, wherein the handover configuration decision defines at least one condition required to cause the at least one access network node to trigger a handover of a UE to a neighbouring cell.

### Supplementary Note A30

The method according to Supplementary Note A29, wherein the at least one condition comprises at least one of: i) a number of measurement events signalled by a UE before triggering handover of that UE to a neighbouring cell, and ii) a time elapsed after a measurement event before handover of the UE is triggered.

### Supplementary Note A31

The method according to any one of Supplementary Notes A25 to A30, wherein the UE handover decision identifies at least one UE that is served by the at least one access network node and a target cell to which the at least one UE is to be handed over.

### Supplementary Note A32

A method performed by a model training function of a communication network, the method comprising:
receiving input data from at least one of a plurality of access network nodes, the input data including at least one data item selected from the group of:
i) at least one Synchronisation Signal Block, SSB, index of an SSB that overlaps with a cell of at least one neighbour access network node and a number of UEs on that SSB;
ii) hardware load data indicating a hardware load of the access network node;
iii) radio resource load data indicating a radio resource load of the access network node; and
iv) purpose data indicating a purpose of a model to be trained or to be updated by the second node;
training a model using the input data and outputting the trained model to a model inference function of the communication network.

### Supplementary Note A33

An access network node of a communication network, the access network node comprising:
means for receiving one or more user equipment, UE, measurement reports from one or more UEs served by the access network node; and
means for sending input data to a second node of the communication network, the input data including at least one data item selected from the group of:
i) at least one Synchronisation Signal Block, SSB, index of an SSB that overlaps with a cell of at least one neighbour access network node and a number of UEs on that SSB;
ii) hardware load data indicating a hardware load of the access network node;
iii) radio resource load data indicating a radio resource load of the access network node; and
iv) purpose data indicating a purpose of a model to be trained or to be updated by the other node.

### Supplementary Note A34

An access network node comprising:
means for receiving a model from a model training function, the model comprising a mapping table which associates a power of at least one Synchronisation Signal Block, SSB, of the access network node with a number of User Equipment, UE, that provide a measurement report for at least one neighbour access network node;
means for receiving input information from the at least one neighbour access network node;
means for receiving one or more user equipment, UE, measurement reports from one or more UEs served by the access network node; and
means for using the input information from the at least one neighbour access network node, at least one of the UE measurement reports and the model to determine at least one load balancing action to be performed by the access network node.

### Supplementary Note A35

A communication network comprising:
means for receiving input data from at least one of a plurality of access network nodes; and
means for using the input data from the at least one of a plurality of access network nodes and a model obtained from a model training function to determine at least one load prediction for at least one of the plurality of access network nodes, the load prediction including at least one data item selected from the group of:
i) a total number of User Equipment, UEs, that are served by the at least one access network node;
ii) a number of UEs per SSB of the at least one access network node;
iii) a number of UEs that are served by the at least one access network node that will send a measurement report identifying a given neighbouring cell; and
iv) a predicted Radio Resource Load for the at least one access network node.

### Supplementary Note A36

A model training function of a communication network, the model training function comprising:
means for receiving input data from at least one of a plurality of access network nodes, the input data including at least one data item selected from the group of:
i) at least one Synchronisation Signal Block, SSB, index of an SSB that overlaps with a cell of at least one neighbour access network node and a number of UEs on that SSB;
ii) hardware load data indicating a hardware load of the access network node;
iii) radio resource load data indicating a radio resource load of the access network node; and
iv) purpose data indicating a purpose of a model to be trained or to be updated by the second node;
means for training a model using the input data and outputting the trained model to a model inference function of the communication network.

### Supplementary Note A37

A computer implementable instructions product comprising computer implementable instructions for comprising a programmable computer device to perform the method of any one of Supplementary Notes A1 to A32.

### Supplementary Note B1

A method performed by an access network node of a communication network, the method comprising:
sending, to another node of the communication network, input data including at least one data item from a group of:
i) at least one Synchronisation Signal Block, SSB, index of an SSB that overlaps with a cell of the another node and a number of UE per the SSB that overlaps with the cell of the another node;
ii) hardware load data indicating a hardware load of the access network node;
iii) radio resource load data indicating a radio resource load of the access network node; and
iv) purpose data indicating a purpose of a model to be trained or to be updated by the another node, wherein
the input data is used for training a model for outputting at least one parameter for load balancing.

### Supplementary Note B2

The method according to Supplementary Note B1, wherein
in a case where the input data includes the radio resource load data, the input data indicates a usage of physical resource blocks, PRBs, by the access network node.

### Supplementary Note B3

The method according to Supplementary Note B1 or B2, wherein
in a case where the input data includes the hardware load data or the radio resource load data, the input data represents a filtered average load of the access network load over a past certain period.

### Supplementary Note B4

The method according to Supplementary Note B3, wherein the filtered average load is represented by a general load state descriptor or by a percentage of a predetermined load.

### Supplementary Note B5

The method according to any one of Supplementary Notes B1 to B4, wherein
in a case where the input data includes the purpose data, the purpose data includes one of Load Balancing, Mobility Robustness, Energy Saving.

### Supplementary Note B6

The method according to any one of Supplementary Notes B1 to B5, further comprising:
receiving measurement reports from one or more user equipments, UEs, served by the access network node or another access network node, and wherein
the sending is performed by sending the input data together with the measurement reports.

### Supplementary Note B7

The method of any one of Supplementary Notes B1 to B6, further comprising:
receiving the model trained by the input data; and
using the model to output the at least one parameter for load balancing.

### Supplementary Note B8

The method any one of Supplementary Notes B1 to B7, wherein
the model includes a mapping table which associates a power of at least one SSB of the access network node with a number of UEs that provide at least one measurement report for at least one access network node which is neighbour to the access network node.

### Supplementary Note B9

A method performed by an access network node, the method comprising:
receiving a model including a mapping table which associates a power of at least one Synchronisation Signal Block, SSB, of the access network node with a number of user equipments, UEs, that provide at least one measurement report for at least one neighbouring access network node which is neighbour to the access network node;
receiving input information from the at least one neighbouring access network node; and
using the input information and the model to determine at least one load balancing action to be performed by the access network node, wherein
the input information includes at least one data item from a group of:
i) at least one Synchronisation Signal Block, SSB, index of an SSB that overlaps with a cell of each of the at least one neighbouring access network node and a number of UE per the SSB that overlaps with the cell of the each of the at least one neighbouring access network node;
ii) hardware load data indicating a hardware load of the access network node; and
iii) radio resource load data indicating a radio resource load of the access network node.

### Supplementary Note B10

The method according to Supplementary Note B9, wherein the at least one load balancing action includes varying a transmit power of the at least one SSB.

### Supplementary Note B11

The method according to Supplementary Note B9 or B10, wherein the at least one load balancing action includes at least one of:
decreasing the transmit power of the at least one SSB,
increasing the transmit power of the at least one SSB,
changing at least one handover decision parameter used by the access network node to determine when to handover a UE to a neighbouring access network node,
changing a number of measurement events that trigger handover of a UE to a neighbouring access network node,
changing a time elapsed after measurement events are reported to trigger handover, and
changing a measurement configuration for at least one UE and transmitting the measurement configuration to the at least one UE,

### Supplementary Note B12

The method according to Supplementary Note B11, wherein the at least one load balancing action is occurred in a case where at least one of:
a loading on the SSB is greater than a loading on the at least one neighbouring access network node, and
a loading on the at least one neighbouring access network node is greater than a loading on the at least one SSB.

### Supplementary Note B13

The method according to Supplementary Note B12, wherein the at least one load balancing action includes decreasing the transmit power of the at least one SSB in a case where a loading on the SSB is greater than a loading on the at least one neighbouring access network node.

### Supplementary Note B14

The method according to Supplementary Note B12, wherein the at least one load balancing action includes increasing the transmit power of the at least one SSB in a case where a loading on the at least one neighbouring access network node is greater than a loading on the at least one SSB.

### Supplementary Note B15

The method according to any one of Supplementary Notes B12 to B14, wherein
the at least one action includes changing a measurement configuration for at least one UE and transmitting the measurement configuration to the at least one UE, and
the measurement configuration defines the circumstances that cause the at least one UE to send a measurement report to the access network node.

### Supplementary Note B16

The method according to any one of Supplementary Notes B9 to B15, further comprising:
transmitting another input information relating to a load on the access network node to a neighbouring access network node for load balancing purposes, wherein
the another input information includes at least one data item from a group of:
SSB index of an SSB that overlaps with a cell of the neighbouring access network node and a number of UE per the SSB that overlaps with the cell of the neighbouring access network node,
hardware load, and
radio resource load.

### Supplementary Note B17

The method according to any one of Supplementary Notes B9 to B16, further comprising:
receiving measurement reports transmitted from one or more user equipments, UEs, served by the access network node or another access network node, and wherein
the using is performed using the measurement reports.

### Supplementary Note B18

A method performed in a communication network, the method comprising:
receiving input data from at least one of a plurality of access network nodes; and
using the input data from the at least one of the plurality of access network nodes and a model to determine at least one load prediction for the at least one of the plurality of access network nodes, wherein
the at least one load prediction includes at least one data item from a group of:
i) a total number of user equipment, UEs, that are served by the at least one access network node;
ii) a number of UEs per Synchronisation Signal Block, SSB, of the at least one access network node;
iii) a number of UEs that are served by the at least one access network node that will send a measurement report identifying a given neighbouring cell; and
iv) a predicted Radio Resource Load for the at least one access network node, and
the input data includes at least one of:
i) at least one SSB index of an SSB that overlaps with a cell of a neighbouring access network node which is a neighbour to one of the at least one access network node and a number of UE per the SSB that overlaps with the cell of the neighbouring access network node;
ii) hardware load data indicating a hardware load of the access network node;
iii) radio resource load data indicating a radio resource load of the access network node; and
iv) purpose data indicating a purpose of the model to be trained or to be updated.

### Supplementary Note B19

The method according to Supplementary Note B18, wherein at least one of the data items of the at least one load prediction includes a deviation from a predicted number which is indicated by the at least one of the data items.

### Supplementary Note B20

The method according to Supplementary Note B18 or B19, wherein
in a case where at least one of the data items of the at least one load prediction includes a predicted Radio Resource load for the at least one access network node, the predicted Radio Resource Load includes a Physical Resource Block usage per cell or per SSB.

### Supplementary Note B21

The method according to any one of Supplementary Notes B18 to B20, further comprising receiving the model from a model training function.

### Supplementary Note B22

The method according to any one of Supplementary Notes B18 to B21, further comprising:
using the at least one load prediction, the model and input data from neighbour access network node or UE to determine a load balancing command for at least one access network node, the load balancing command including at least one data item from a group of:
i) a power parameter;
ii) a measurement configuration;
iii) a handover decision configuration; and
iv) a UE handover decision.

### Supplementary Note B23

The method according to Supplementary Note B22, wherein the method is performed by a model inference node or an access network node of the communication network.

### Supplementary Note B24

The method of Supplementary Note B22 or B23, wherein the power parameter is a cell, SSB beam or site power parameter.

### Supplementary Note B25

The method according to any one of Supplementary Notes B22 to B24, wherein the measurement configuration is for a UE and defines the circumstances that cause the UE to send a measurement report to the access network node.

### Supplementary Note B26

The method according to any one of Supplementary Notes B22 to B25, wherein the handover configuration decision defines at least one condition required to cause the at least one access network node to trigger a handover of a UE to a neighbouring cell.

### Supplementary Note B27

The method according to Supplementary Note B26, wherein the at least one condition comprises at least one of:
i) a number of measurement events signalled by a UE before triggering handover of that UE to a neighbouring cell, and
ii) a time elapsed after a measurement event before handover of the UE is triggered.

### Supplementary Note B28

The method according to any one of Supplementary Notes B22 to B27, wherein the UE handover decision identifies at least one UE that is served by the at least one access network node and a target cell to which the at least one UE is to be handed over.

### Supplementary Note B29

An access network node of a communication network, the access network node comprising:
means for sending to another node of the communication network, input data including at least one data item from a group of:
i) at least one Synchronisation Signal Block, SSB, index of an SSB that overlaps with a cell of another node and a number of UE per the SSB that overlaps with the cell of the another node;
ii) hardware load data indicating a hardware load of the access network node;
iii) radio resource load data indicating a radio resource load of the access network node; and
iv) purpose data indicating a purpose of a model to be trained or to be updated by the another node
wherein the input data is used for training a model for outputting at least one parameter for load balancing.

### Supplementary Note B30

An access network node comprising:
means for receiving a model including a mapping table which associates a power of at least one Synchronisation Signal Block, SSB, of the access network node with a number of user equipments, UEs, that provide at least one measurement report for at least one neighbouring access network node which is neighbour to the access network node;
means for receiving input information from the at least one neighbouring access network node; and
means for using the input information and the model to determine at least one load balancing action to be performed by the access network node, wherein the input information includes at least one data item from a group of:
i) at least one Synchronisation Signal Block, SSB, index of an SSB that overlaps with a cell of each of the at least one neighbouring access network node and a number of UE per the SSB that overlaps with the cell of the each of the at least one neighbouring access network node;
ii) hardware load data indicating a hardware load of the access network node; and
iii) radio resource load data indicating a radio resource load of the access network node.

### Supplementary Note B31

A communication network comprising:
means for receiving input data from at least one of a plurality of access network nodes; and
means for using the input data from the at least one of the plurality of access network nodes and a model to determine at least one load prediction for the at least one of the plurality of access network nodes, wherein the at least one load prediction includes at least one data item from a group of:
i) a total number of user equipments, UEs, that are served by the at least one access network node;
ii) a number of UEs per Synchronisation Signal Block, SSB, of the at least one access network node;
iii) a number of UEs that are served by the at least one access network node that will send a measurement report identifying a given neighbouring cell; and
iv) a predicted Radio Resource Load for the at least one access network node, and
the input data includes at least one of:
i) at least one SSB index of an SSB that overlaps with a cell of a neighbouring access network node which is neighbour to one of the at least one access network node and a number of UE per the SSB that overlaps with the cell of the neighbouring access network node;
ii) hardware load data indicating a hardware load of the access network node;
iii) radio resource load data indicating a radio resource load of the access network node; and
iv) purpose data indicating a purpose of the model to be trained or to be updated.

This application is based upon and claims the benefit of priority from Great Britain Patent Application No. 2211627.1, filed on Aug. 9, 2022, the disclosure of which is incorporated herein in its entirety by reference.

### REFERENCE SIGNS LIST

1 mobile (cellular or wireless) telecommunication system
3 mobile device
5 base station
6 cell(s)
7 core network
8-1 Access and Mobility Management Function (AMF)
8-2 control plane function (CPF)
8-3 user plane function (UPF)
8-4 Session Management Function (SMF)
8-5 Operations, Administration and Maintenance (OAM) function
20 data network
31 transceiver circuit
33 antennas
35 user interface
37 controller
39 memory
41 operating system
43 communications control module
45 energy saving module
51 transceiver circuit
53 antennas
55 network interface
57 controller
59 memory
61 operating system
63 communications control module
65 energy saving module
71 transceiver circuit
75 network interface
77 controller
79 memory
81 operating system
83 communications control module
85 energy saving module
91 data collection function
93 model training function
95 model inference function
97 actor

What is claimed is:

1.-32. (canceled)

33. A method performed by a communication network node, the method comprising:
receiving, from an access network node, input data including at least one of:
information indicating a number of user equipments (UEs), or
information indicating a respective radio resource load per Synchronisation Signal/Physical Broadcast Channel (PBCH) Block (SSB) and information for a respective SSB index per SSB; and
using the input data and a model to determine at least one load prediction.

34. The method according to claim 33, further comprising:
using the at least one load prediction, the model and the input data to determine a command including information for a handover decision, for at least one access network node.

35. The method according to claim 34, wherein
the command indicates conditions for the UE to send a measurement report to the access network node.

36. The method according to claim 33, further comprising:
receiving, from the UE, a measurement report, and wherein
the using is performed by using the measurement report, the input data and the model to determine the at least one load prediction.

37. A communication network node comprising:
at least one memory storing instructions; and
at least one processor configured to process the instructions to:
receive, from an access network node, input data including at least one of:
information indicating a number of user equipments (UEs), or
information indicating a respective radio resource load per Synchronisation Signal/Physical Broadcast Channel (PBCH) Block (SSB) and information for a respective SSB index per SSB; and
use the input data and a model to determine at least one load prediction.
